(19) United States
(12) Patent Application Publication
(10) Pub. No.: US 2008/0301661 A1
(43) Pub. Date: Dec. 4, 2008

(54) INDICATION OF NEW FEATURES IN A SOFTWARE USER INTERFACE

(76) Inventors: Thomas R. Haynes, Apex, NC (US); Lin Sun, Morrisville, NC (US)

Correspondence Address: DILLON & YUDELL LLP, 8911 N. CAPITAL OF TEXAS HWY., SUITE 2110, AUSTIN, TX, 78759, US

(21) Appl. No.: 11/756,099

(22) Filed: May 31, 2007

(51) Int. Cl. G06F 9/445; G06F 17/00; G06F 17/20

(52) U.S. Cl. 717/170; 715/229

(57) ABSTRACT

A method, system and computer-readable medium for indicating new features in a software user interface are presented. In one embodiment, the method detects a version identifier corresponding to an element of a software user interface. The version identifier associates the element with a particular version of the software user interface. The method detects a preference setting for the software user interface. The preference setting designates one or more version identifiers for which corresponding elements are displayed with a visual coding. The method displays one or more user interface elements with said visual coding to a user. The visual coding indicates the elements that correspond to the version identifiers designated by the preference setting.

### BACKGROUND OF THE INVENTION

The present invention relates in general to the field of computers and similar technologies, and in particular to software utilized in this field. Still more particularly, the present invention relates to graphical user interfaces of software utilized in this field.

Producers of computer software today commonly offer new releases of a product periodically. Customers naturally want to use and run the latest and greatest versions of these software products. The upgrades can be made in a number of ways, such as uninstalling the old version and installing the new one, or installing the update directly over the existing software. In any case, once the update has occurred the user understandably would like to know what has changed: how does the new version differ compared to the old version.

Currently customers rely on reading “What's New” documentation (e.g., README files), Web sites, etc. to ascertain the changes between versions. Many users do not want to have to resort to reading accompanying literature. Instead, they prefer to “play” with the interface to figure out what is new or different in the upgraded version of the software. However, interfaces today do not provide a uniform, structured way to display changes to the user interface to a user following an upgrade.

### BRIEF SUMMARY OF THE INVENTION

The present invention thus provides a method, system and computer-readable medium for indicating new features in a software user interface. In one embodiment, the method detects a version identifier corresponding to an element of a software user interface. The version identifier associates the element with a particular version of the software user interface. The method detects a preference setting for the software user interface. The preference setting designates one or more version identifiers for which corresponding elements are displayed with a visual coding. The method determines whether the version identifier of a user interface element is included in the preference setting and, if so, displays the user interface element with said visual coding to a user. The visual coding indicates the elements that correspond to the version identifiers designated by the preference setting.

The above, as well as additional purposes, features, and advantages of the present invention will become apparent in the following detailed written description.

### BRIEF DESCRIPTION OF THE SEVERAL VIEWS OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an exemplary data processing system in which the present invention may implemented;

FIG. 2 depicts an exemplary user interface of a software application in which features are indicated to the user in accordance one or more embodiments of the present invention; and

FIG. 3 is a block diagram demonstrating a method for highlighting new or changed user interface elements in accordance with one or more embodiments of the present invention.

FIG. 4 is a flowchart showing an exemplary process for providing an indication of a new or updated element in a software user interface.

### DETAILED DESCRIPTION OF THE INVENTION

A preferred embodiment of the present invention is directed to a software user interface, and associated methods of presenting a software user interface to a user of a data processing system. The present invention can take the form of an entirely hardware embodiment, an entirely software embodiment or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

The medium can be an electronic, magnetic, optical, electromagnetic, infrared or semiconductor system, apparatus or device or a propagation medium. Examples of a computer-readable medium include a semiconductor or solid state memory (e.g., flash drive memory), magnetic tape, a removable computer diskette, a random access memory (RAM), a read-only memory (ROM), a rigid magnetic disk (e.g., a hard drive) and an optical disk. Current examples of optical disks include compact disk—read only memory (CD-ROM), compact disk—read/write (CD-R/W) and Digital Versatile Disk (DVD).

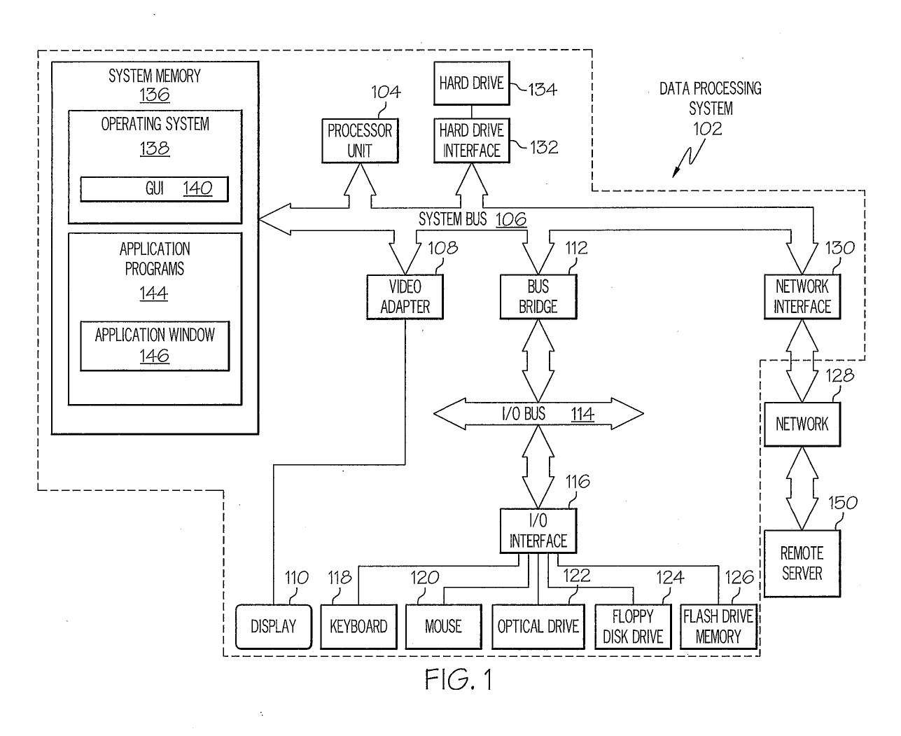

Referring now to the drawings, wherein like numbers denote like parts throughout the several views, FIG. 1 shows a block diagram of a data processing system suitable for storing and/or executing program code in accordance with one or more embodiments of the present invention. The hardware elements depicted in data processing system 102 are not intended to be exhaustive, but rather are representative to highlight essential components required by the present invention. Data processing system 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, an optical disk drive 122, a floppy disk drive 124, and a flash drive memory 126. The format of the ports connected to I/O interface 116 may be any known to those skilled in the art of computer architecture, including but not limited to Universal Serial Bus (USB) ports.

Data processing system 102 is able to communicate with a remote server 150 via a network 128 using a network interface 130, which is coupled to system bus 106. Network 128 may be an external network such as the Internet, or an internal network such as an Ethernet or a Virtual Private Network (VPN). Remote server 150 may utilize a similar architecture design as that described for data processing system 102.

A hard drive interface 132 is also coupled to system bus 106. Hard drive interface 132 interfaces with hard drive 134. In a preferred embodiment, hard drive 134 populates a system memory 136, which is also coupled to system bus 106. Data that populates system memory 136 includes an operating system (OS) 138 of data processing system 102 and application programs 144.

OS 138 (e.g., UNIX®, Windows®) is a set of computer programs that manage the hardware and software resources of data processing system 102, including memory management, process and task management, disk management, and mouse and keyboard management. OS 138 includes a graphical user interface (GUI) 140 for providing user access to resources such as system settings, files stored in memory, and application programs, such as application program 144. Application program 144 is also presented to a user in a graphical format via application window 146. A user utilizes an input device such as mouse 120 to interact with the graphical elements of GUI 140 and application window 146.

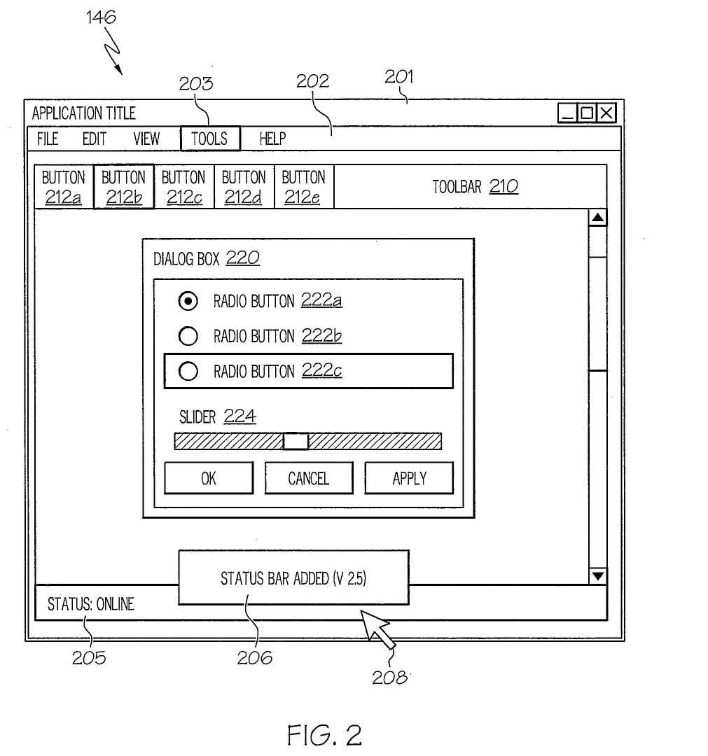

With reference now to FIG. 2, a diagram of application window 146 is shown in which one or more embodiments of the present invention can be implemented. While application window 146 is used for purposes of illustration, the present invention can be utilized with other aspects of GUI 140 and is not limited to an application window and the elements displayed therein. Application window 146 comprises common user interface elements such as title bar 201, menu bar 202, toolbar 210, and status bar 205. Title bar 201 displays the title of the application and/or the filename of the file that is being edited. Menu bar 202 displays menu titles such as “File”, “Edit”, “View”, “Tools” and “Help”. A dropdown menu is displayed when a user positions a pointer 208 over a menu title with an input device such as mouse 120 and presses a button on mouse 120 while pointer 208 is positioned over a menu title. A user may use mouse 120 to select a command for application program 144 to perform from the dropdown menu. Toolbar 210 displays a number of graphical icons (e.g., buttons 212a-e). A user may also select a command by “pressing” one of buttons 212a-e using mouse 120. Status bar 105 can be used to display the status of application program 144, such as “online” or “offline”. Application program 144 may also comprise a dialog box 220, which is displayed in response to a particular command selected by the user and prompts the user to input specific information. For example, dialog box 220 comprises radio buttons 222a-c and slider 224, which are used to adjust settings or set preferences for application program 144.

Developers of computer software commonly release new or updated versions of a software product periodically. User interface elements, such as those described with reference to FIG. 2, may be added or changed in an updated version of the software product. In accordance with a preferred embodiment of the present invention, elements of a software user interface that are new or updated in a particular version of the software product are displayed with a visual coding that highlights the new or updated elements. This makes it easier for a user to find, learn about and experiment with new or updated features of a particular version of software. User interface elements are “tagged” with a version identifier that associates changes in the element with a particular version of the software product. By default, a preference setting can be made during installation of a particular version of software to highlight those elements that are new or changed with that particular version. Once installed, the software may have an option that allows a user to define a preference setting that designates the versions for which elements of the user interface will be highlighted. For example, the user can set a preference for versions 3.0, 3.1 and 3.2. Any elements of the user interface that were added or changed in versions 3.0, 3.1 or 3.2 will be highlighted.

The visual coding can be any means for highlighting an element of a graphical user interface. For example, a boldface border can be displayed around an element to highlight that element. An example of a boldface border is shown in FIG. 2 around button 212b, radio button 222c and status bar 205. The boldface border around those elements indicates that they are new or changed in the version(s) of the user interface designated by the preference setting. In addition to or as an alternative to a boldface border, the visual coding may include a colored border or colored background that is displayed behind an element. Different colors can be used to indicate elements that were added or changed with different versions of the user interface. For example, blue could be used to indicate version 3.0 and red can be used indicate version 4.0. Different shades of color can be used to indicate the degree of change. For example, an element with a background that is a fall shade of blue can be used to represent a completely new user interface element that was added in version 3.0. An element with a background that is a paler shade of blue is a user interface element that is changed in version 3.0, but existing in earlier versions of the user interface. The shading can be displayed in varying degrees to indicate the extent of a change to the element in a particular version.

The visual coding can also include a hover window 206. When a user positions pointer 208 over a new or changed user interface element, after a predefined interval of time hover window 206 will be displayed in close proximity to pointer 208. Hover window 208 can display information about the user interface element, such as “Status Bar Added (v 2.5)”. Similarly, information of this type can be displayed via a contextual menu that appears when a user positions pointer 208 over a new or changed user interface element and depresses an alternate button on mouse 120 (e.g., right-click properties).

In addition to adding visual coding to new or changed user interface elements, visual coding can be added to user interface artifacts that lead to a new or changed user interface element. For example, radio button 222c displayed in dialog box 220 is new to version 3.0. A user accesses dialog box 220 via a command in Tools menu 203. Tools menu 203 is displayed with a boldface border, which indicates to the user that an element accessed via Tools menu 203 has been added or changed. In addition, the command within Tools menu 203 that displays dialog box 220 can be displayed with a boldface border.

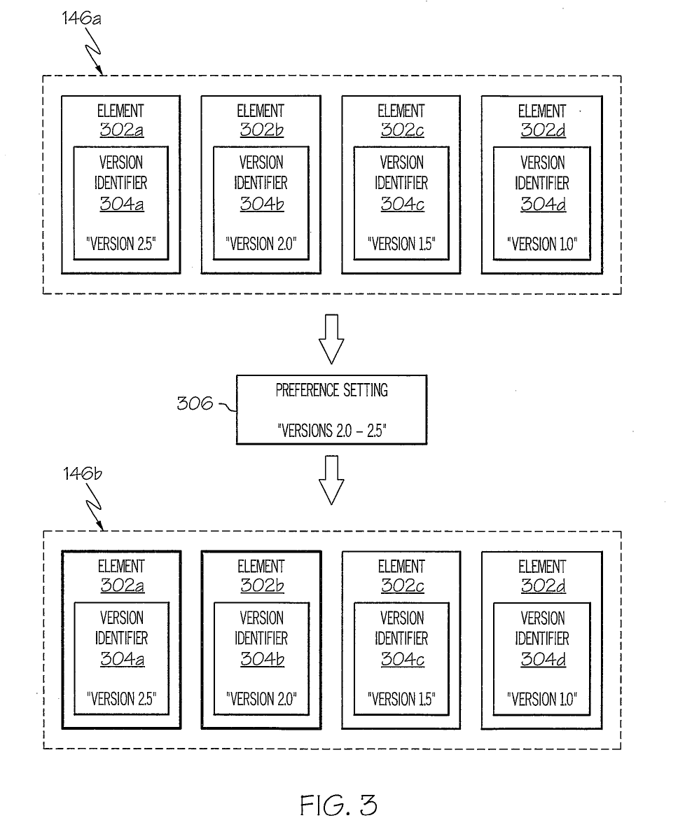

With reference now to FIG. 3, a block diagram is shown that demonstrates a method for highlighting new or changed user interface elements in accordance with one or more embodiments of the present invention. Application window 146a includes user interface elements 302a-d. Exemplary user interface elements 302a-d are GUI widgets and windowing structures, such as those described with reference to FIG. 2. User interface elements 302a-d include a respective version identifier 304a-d. Version identifiers 304a-d indicate each software version for which respective user interface elements 302a-d are new or changed. Developers can “tag” the added or changed user interface elements with a version identifier. The version identifiers can be defined up front so that their relationship is understood. For example, version 1.0 is defined as older than version 1.1, version 1.1 is defined as older than v.2.0, and so on. All tagging would be completely under developer control. So, for instance, if the developer thinks that a dialog box is completely new to the release, he can tag that dialog box accordingly with the appropriate version identifier. Writers could also tag sections of accompanying documentation (e.g., online help files, hard-copy books).

Application window 146b shows user interface elements 302a-d displayed in accordance with one or more aspects of the present invention. A preference setting 306 defines one or more software versions for which new or changed user interface elements are indicated to a user. User interface elements with matching version identifiers are displayed with visual coding. In the example shown in FIG. 3, preference setting 306 defines which of user interface elements 302a-d are displayed with a visual coding. Preference setting 306 indicates version 2.0 through version 2.5. User interface element 302a is displayed with a bold border because its corresponding version identifier 304a is included in preference setting 306. Likewise, user interface element 302b is displayed with a bold border because its corresponding version identifier 304b is included in preference setting 306. User interface elements 302c and 302d are not displayed with a bold border because their corresponding version identifiers 304c and 304d are included in preference setting 306.

When a computer program product is installed or upgraded on data processing system 102, by default preference setting 306 can automatically be set to highlight new or changed user interface elements. Alternatively, the installing program may prompt the user for a preference setting upon installation. After the installation or upgrade is complete, preference setting 306 subsequently can be set by the user. This enables the user to define which new or changed user interface elements will be highlighted according to software version.

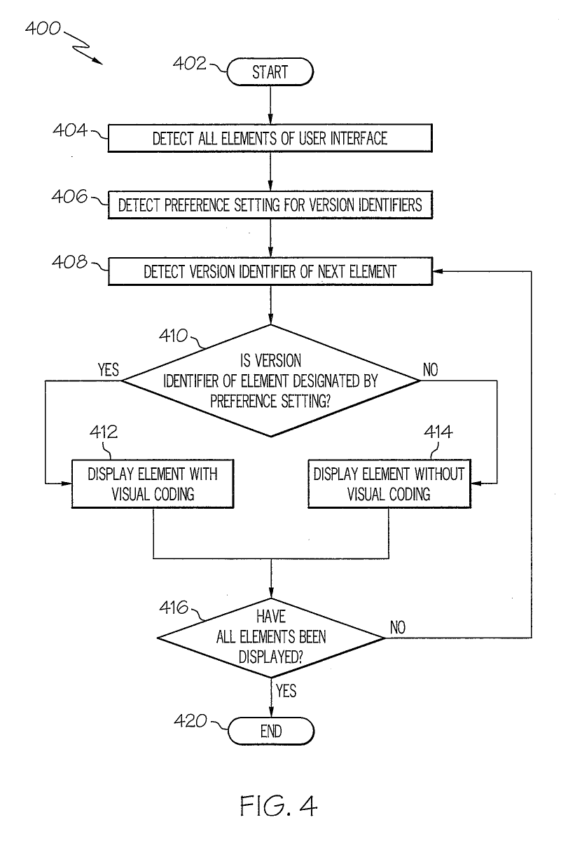

With reference now to FIG. 4, a flowchart is shown that depicts an exemplary process for providing an indication of a new or updated element in a software user interface. The process begins at initiator block 402. The process detects all elements of a software user interface (step 404) and a preference setting (step 406). The preference setting designates one or more version identifiers that will be used determine which elements are displayed with a visual coding. In step 408, the process detects the version identifier of the next element (in this case the first element). In step 410 the process determines whether the version identifier of the element is designated by the preference setting. If so, the process displays the element with a visual coding (step 412). If not, the process displays the element without any visual coding (step 414). The process then checks to see if all of the elements of the user interface have been displayed (step 416). If so, the process proceeds to terminator block 420 and ends. If not, the process returns to step 408 and proceeds with the next remaining element.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants PDA's), telephones, and any other system capable of processing, transmitting, receiving, capturing and/or storing data.

The flowchart and diagrams in the Figures illustrate the architecture, functionality, and operation of possible implementations of systems, methods and computer program products according to various embodiments of the present invention. In this regard, each block in the flowchart or diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method comprising:
detecting a version identifier of a first user interface element, wherein the version identifier associates the first user interface element with a particular version of a computer program product;
detecting a preference setting of said computer program product, wherein said preference setting indicates one or more version identifiers;
determining whether the preference setting indicates the version identifier of said first user interface element; and
in response to determining the preference setting indicates the version identifier of said first user interface element, displaying to a user said first user interface element with a visual coding.

2. The method of claim 1, further comprising:
displaying a second user interface element with a visual coding, wherein said second user interface element provides user access to said first user interface element.

3. The method of claim 1, wherein said visual coding comprises a colored background displayed behind the elements displayed with said visual coding.

4. The method of claim 3, wherein a shading of said colored background indicates the degree to which the element has changed from an earlier version of said computer program product.

5. The method of claim 1, wherein said visual coding comprises a bolded border around the elements displayed with said visual coding.

6. A system comprising:
means for detecting a version identifier of a first user interface element, wherein the version identifier associates the first user interface element with a particular version of a computer program product;
means for detecting a preference setting of said computer program product, wherein said preference setting indicates one or more version identifiers;
means for determining whether the preference setting indicates the version identifier of said first user interface element; and
means, responsive to determining the preference setting indicates the version identifier of said first user interface element, for displaying to a user said first user interface element with a visual coding.

7. The system of claim 6, further comprising:
means for displaying a second user interface element with a visual coding, wherein said second user interface element provides user access to said first user interface element.

8. The system of claim 6, wherein said visual coding comprises a colored background displayed behind the elements displayed with said visual coding.

9. The system of claim 8, wherein a shading of said colored background indicates the degree to which the element has changed from an earlier version of said computer program product.

10. The system of claim 6, wherein said visual coding comprises a bolded border around the elements displayed with said visual coding.

11. A computer-readable medium encoded with a computer program product that, when executed, performs the steps of:
detecting a version identifier of a first user interface element, wherein the version identifier associates the first user interface element with a particular version of a computer program product;
detecting a preference setting of said computer program product, wherein said preference setting indicates one or more version identifiers;
determining whether the preference setting indicates the version identifier of said first user interface element; and
in response to determining the preference setting indicates the version identifier of said first user interface element, displaying to a user said first user interface element with a visual coding.

12. The computer-readable medium of claim 11, further comprising:
displaying a second user interface element with a visual coding, wherein said second user interface element provides user access to said first user interface element.

13. The computer-readable medium of claim 11, wherein said visual coding comprises a colored background displayed behind the elements displayed with said visual coding.

14. The computer-readable medium of claim 13, wherein a shading of said colored background indicates the degree to which the element has changed from an earlier version of said computer program product.

15. The computer-readable medium of claim 11, wherein said visual coding comprises a bolded border around the elements displayed with said visual coding.
